(19) United States
(12) Patent Application Publication
(10) Pub. No.: US 2012/0216501 A1
(43) Pub. Date: Aug. 30, 2012

(54) Chemical reactor featuring heat extraction

(75) Inventors: Roland Birley, Bamberg (DE); Frank Hannemann, Freiberg (DE); Daniel Hofmann, Uttenreuth (DE); Nicolas Vortmeyer, Erlangen (DE)

(73) Assignee: Siemens Aktiengellsschaft, Munchen (DE)

(21) Appl. No.: 13/505,755

(22) PCT Filed: Oct. 26, 2010
(86) PCT No.: PCT/EP10/66140

§ 371 Date: May 3, 2012

(30) Foreign Application Priority Data
Nov. 4, 2009 (DE) 10-2009051938.6

(51) Int. Cl. F02C 3/28; C01B 3/16; B01J 7/00

(52) U.S. Cl. 60/39.12; 422/162; 252/373

(57) ABSTRACT

A chemical reactor of a technical plant, in particular a power plant system is provided. The chemical reactor includes a gas-tight wall forming a gas channel, wherein heat exchanger surfaces that are permeable with a first fluid and at least partially include a catalytically active surface are located in the gas channel. A method for converting CO using such a reactor is also provided.

### CROSS REFERENCE TO RELATED APPLICATIONS

This application is the U.S. National Stage of International Application No. PCT/EP2010/066140, filed Oct. 26, 2010 and claims the benefit thereof. The International Application claims the benefits of German application No. 10 2009 051 938.6 DE filed Nov. 4, 2009. All of the applications are incorporated by reference herein in their entirety.

### FIELD OF INVENTION

The invention relates to a chemical reactor featuring continuous heat extraction.

### BACKGROUND OF INVENTION

Coal as a primary energy source is relatively stable as regards price and many countries have their own reserves. In the future new demands will be made on fossil fuel-fired power stations such as lowest emissions and additional CO₂ capture. Integrated Gasification Combined Cycle (IGCC) represents one of the most widely developed power station CO₂ capture concepts. This technology comprises a gasification of the fuel before the actual combined cycle power station (GuD). Since CO₂ capture measures are always associated with a loss of efficiency (8%-12%, depending on the technical boundary conditions), it is important for the realization of an IGCC to strive for a high level of efficiency for the individual subprocesses.

For an IGCC system with CO₂ capture the coal is first converted in a gasifier into what is known as synthetic gas, which essentially consists of carbon monoxide (CO), hydrogen (H₂), carbon dioxide (CO₂) and water (H₂O). The CO is subsequently converted with water as completely as possible into CO₂ and H₂ (CO shift). At a higher temperature fast kinetics but an unfavorable chemical equilibrium is present. At lower temperatures the equilibrium is greater on the right side of the reaction equation, but the kinetics reduce. Therefore at the moment the shift reaction is carried out in one to three stages in order to extract heat between the reactions and if necessary supply water vapor to it. The CO₂ is then captured by an additional wash, compressed and transported to the storage locations. In addition the synthetic gas is cleansed of other pollutants such as dust and sulfur compounds, to meet requirements for clean air and technical requirements in the gas turbine. The remaining hydrogen is thinned with nitrogen and water vapor and burnt in a gas turbine. The hot exhaust gases arising are used for steam generation; the steam is used for further power generation in a steam turbine.

The shift reaction in which hydrogen and CO₂ is currently produced from CO by adding water vapor in the presence of a catalytic converter is strongly exothermic and needs a lot of water vapor (both for the reaction and also for the reduction of the temperature). This step has a significant influence on the efficiency in the process.

### SUMMARY OF INVENTION

The object is to develop the shift reactor and the CO shift method so that an improved plant efficiency is achieved.

According to the invention this object is achieved by the device in accordance with the claims and the method in accordance with the claims. Advantageous developments of the invention are defined in the respective dependent claims. By a number of heat exchanger surfaces in a chemical reactor with a gas-tight wall which forms a gas channel being arranged in the gas channel through which a first fluid is able to flow and which feature at least partly a catalytically-effective surface and a number of feed devices being provided for a second fluid, the following is achieved:

With a low pressure loss heat can be continuously removed from the process and thereby an improved temperature control (constant or biased towards optimization of the process) of the shift process can be achieved. The catalytically-effective surfaces would lie on the heat exchanger outer surfaces passed by the raw gas and the heat can be emitted directly to a suitable medium.

In this case it is expedient for the surface of the heat exchanger surfaces to catalyze or cause a conversion of carbon monoxide and water into hydrogen and carbon dioxide.

In a preferred embodiment the gas-tight wall likewise features a catalytically-effective surface. This enables the catalytically-effective surface to be increased while the pressure loss remains at the same low level.

In an advantageous manner the feed devices for the second fluid are arranged in the gas channel distributed in a direction of a longitudinal axis of the gas channel, wherein the second fluid is expediently water which must be supplied to the shift process. The staged addition of water has the advantage of being able to use the smallest possible amount of additional water (precisely as much as is necessary for the process) in order to achieve the highest possible efficiency.

For better distribution or mixing in of the supplied water with the gas flow it is expedient for the supply devices to be injection apparatuses.

Advantageously the gas channel is embodied as a horizontal structure and the gas is able to flow through it in an essentially horizontal direction, wherein the heat exchanger surfaces are evaporator heat surfaces or economizer heat surfaces. In this way the heat occurring during the conversion can be used directly in the power plant process.

According to an especially advantageous embodiment the reactor is integrated into a power plant system with a gas turbine, a steam turbine and fuel gasification upstream from the gas turbine, wherein it is connected between the fuel gasification and the gas turbine.

In relation to the method for operating a chemical reactor the object is achieved by a gas containing carbon monoxide being conveyed over a number of heat exchanger surfaces with a catalytically-effective surface and the gas being supplied with water distributed in the direction of flow.

In this case it is expedient for the heat exchanger surfaces to be formed by tubes through which water is conveyed, which is heated up by said tubes and can be used in the power plant process at another location.

The shift reaction previously divided up into stages is converted into a quasi-continuous reaction and heat extraction process. The inventive chemical reactor offers larger catalytic converter surfaces and lower pressure losses than the normal loose fill catalytic converter material. The technology is not restricted to IGCC applications but could also be used in other reactions such as the production of synthetic natural gas or substitute natural gas (SNG) for example, a natural gas substitute which is manufactured on the basis of coal, in particular brown coal or biomass (bio SNG or bio methane) via synthetic gas.

If necessary known Benson technologies can be used to extract heat from waste heat steam generators.

### BRIEF DESCRIPTION OF THE DRAWINGS

The invention is explained in greater detail by examples which refer to the drawings. The drawings, which are schematic and not true-to-scale are as follows:

FIG. 1 shows a gasifier with downstream chemical reactor for CO conversion,

FIG. 2 shows a schematic synthetic gas temperature curve over the inventive reactor and

FIG. 3 shows a schematic synthetic gas temperature curve over reactors according to the prior art.

### DETAILED DESCRIPTION OF INVENTION

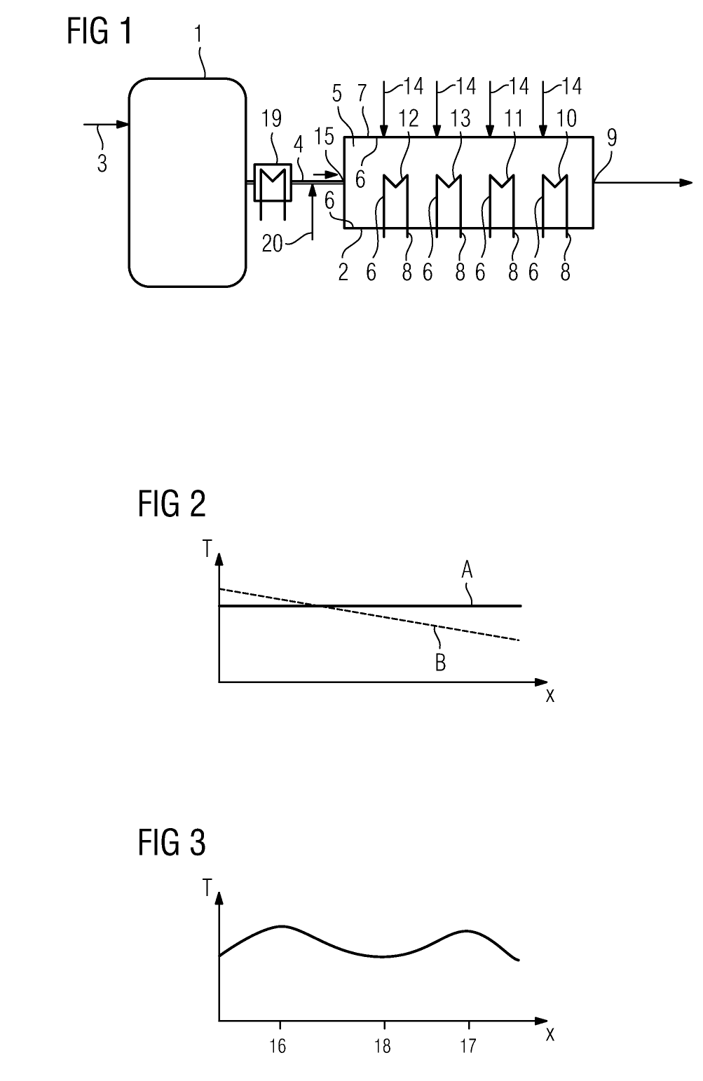

The arrangement in FIG. 1 has two main components: the gasification reactor I and the inventive chemical reactor 2 for the conversion of carbon monoxide.

The materials used 3 (these are fossil or renewable energy carriers and residues, such as natural gas, oil fractions, coals, biomasses and waste materials) are converted in the gasification reactor 1 in a flame reaction. The hot raw gas 4 arising as one of the results of this reaction flows out of the gasification reactor 1 via various stations, such as a waste heat unit 19 for example for cooling the raw gas from the gasification temperature to around 700° C. to 900° C., at which ideally high-pressure steam will be produced, and/or a quench unit 20, in the chemical reactor 2. The objective of the quench is a rise in the proportion of water vapor in the raw gas for the subsequent water gas shift reaction in the chemical reactor 2.

The gas channel 5 of the chemical reactor 2 comprises heat exchanger surfaces 6 constructed from tubes. These can be disposed in the gas channel 5 or also form the surrounding wall 7 of the gas channel 5. In the latter case the steam generator tubes, not shown in any greater detail, are welded on their longitudinal sides gas-tight to one another via bars or what are referred to as fins. A plurality of tubes adjacent to one another is combined in this way into a heat exchanger surface 6. The entry ends 8 of the tubes forming a heat exchanger surface 6 on the downstream flow end 9 of the chemical reactor 2 have feed water applied to them for example by a common entry collector (not shown). The heat exchanger surface 6 in this case is used as an economizer heating surface 10. On the exit side the feed water heated up in the tubes of the economizer heating surface 10 as a result of the heating by the synthetic gas flows via a (not shown) exit collector and is subsequently fed to an evaporator unit. The evaporator unit 11 can likewise be disposed in the chemical reactor 2, for example in the flow direction of the synthetic gas upstream of the economizer heating surface 10. The water preheated by the economizer 10 can also be supplied for the evaporator 11 via an entry collector to the heat exchanger surfaces 6. In the evaporator unit 11 the preheated water is evaporated to low-pressure, medium-pressure or high-pressure steam and, likewise via a corresponding collectors, fed to a superheating unit 12 for example.

The heat exchanger surfaces 6 can also be used for intermediate superheating 13 of the partly relaxed flow medium flowing out of a first turbine stage of a steam turbine, so that the flow medium is then able to be supplied, heated up once more, to the next stage of the steam turbine.

As a result of the heat transfer to the flow medium flowing through the heat exchanger surfaces 6 heat is continuously extracted from the synthetic gas flowing in the gas channel as the flow path progresses. As a result of the water gas shift reaction however heat is produced again. To regulate this reaction and thereby the temperature of the synthetic gas, water is introduced at different points and distributed in the longitudinal direction of the gas channel 5 into the synthetic gas flow. The water is introduced with the aid of an injection apparatus 14. The nozzles of the injection apparatus are set to and aligned so that as small an additional amount of water as possible (precisely as much as is necessary for the process) is provided in order to achieve a highest possible plant efficiency.

The heating surfaces of the economizer and of the evaporator and if necessary superheater are provided with a catalytic converter layer for the water gas shift reaction. The activation energy for the shift reaction, in which carbon monoxide and water are converted into carbon dioxide and hydrogen, is lowered by the catalytic converter material and thereby its kinetics changed.

FIG. 2 shows a schematic of the temperature curve of the synthetic gas from the reactor input 15 to the reactor output 9. By contrast with the use of high-temperature 16 and low-temperature shift stages 17 (see FIG. 3) of the prior art, in the present invention, to optimize the efficiency, the temperature curve can be set or maintained in the chemical reactor 2. In this case this temperature curve is not necessarily horizontal (A), but in accordance with the equilibrium of the water gas shift reaction will tend to fall away (B) towards the end of the gas channel 5, in order to take account of the fact that at a higher temperature a rapid kinetic but an unfavorable chemical equilibrium is present and at lower temperatures the equilibrium is greater on the right side of the reaction equation, but the kinetics reduce. The temperature curve in this case does not have to be linear. Since the carbon monoxide concentration is at its highest at the beginning of this shift reaction, higher temperatures are preferably present at the reactor entry than at the reactor exit. The heat exchanger surfaces 6 are then arranged accordingly in the chemical reactor 2 such that superheater 12, 13 and evaporator 11 are rather on an upstream side of the chemical reactor 2 in the flow direction of the synthetic gas and the economizer 10 is on the downstream side.

FIG. 3 shows the temperature curve as it would appear in the prior art, with the use of a high-temperature 16 and a low-temperature shift stage 17, with heat exchanger 18 connected between them.

1-9. (canceled)

10. A shift reactor for conversion of carbon monoxide of a technical plant, comprising:
a gas-tight wall which forms a gas channel, wherein a number of heat exchanger surfaces are arranged in the gas channel through which a first fluid is able to flow and which have at least in part a catalytically-effective surface,
wherein a pluarlity of supply devices for a second fluid are provided in the gas channel which are arranged distributed in the direction of a longitudinal axis of the gas channel

11. The reactor as claimed in claim 10, wherein the technical plant is a power plant system.

12. The reactor as claimed in claim 10, wherein each surface catalyzes or causes a conversion from carbon monoxide and water into hydrogen and carbon dioxide.

13. The reactor as claimed in claim 10, wherein the gas-tight wall features a catalytically-effective surface.

14. The reactor as claimed in claim 10, wherein the second fluid is water.

15. The reactor as claimed in claim 10, wherein the supply devices are injection devices.

16. The reactor as claimed in claim 10,
wherein the gas channel is embodied as a horizontal construction and gas is essentially able to flow through it in a horizontal direction, and
wherein the heat exchanger surfaces are evaporator heating surfaces or heating surfaces.

17. A power plant, comprising:
a gas turbine;
a steam turbine; and
fuel gasification connected upstream from the gas turbine,
wherein a reactor as claimed in claim 10 is connected between the fuel gasification and the gas turbine.

18. The power plant as claimed in claim 17, wherein each surface of the reactor catalyzes or causes a conversion from carbon monoxide and water into hydrogen and carbon dioxide.

19. The power plant as claimed in claim 17, wherein the gas-tight wall of the reactor features a catalytically-effective surface.

20. The power plant as claimed in claim 17, wherein the second fluid is water.

21. The power plant as claimed in claim 17, wherein the supply devices are injection devices.

22. The power plant as claimed in claim 17,
wherein the gas channel of the reactor is embodied as a horizontal construction and gas is essentially able to flow through it in a horizontal direction, and
wherein the heat exchanger surfaces are evaporator heating surfaces or heating surfaces.

23. A method for operating a shift reactor for a conversion of carbon monoxide,
conveying a gas containing carbon monoxide over a plurality of heat exchanger surfaces with a catalytically-effective surface;
continuously extracting heat from the gas containing carbon monoxide as the flow path progresses; and
supplying precisely as much water as is necessary for the conversion of carbon monoxide distributed to the gas in the flow direction of the gas.

24. The method as claimed in claim 18, wherein the heat exchanger surfaces are formed by tubes through which the water is conveyed.
